(19) United States
(12) Patent Application Publication
(10) Pub. No.: US 2012/0259064 A1
(43) Pub. Date: Oct. 11, 2012

(54) Polymeric or Oligomeric Active Ingredients Having a Biocidal Effect, Method for the Production Thereof, and Composition Comprising a Polymeric or Oligomeric Active Ingredient

(76) Inventors: Andreas Greiner, Amoneburg (DE); Seema Agarwal, Marburg (DE); Claudia Mattheis, Marburg (DE)

(21) Appl. No.: 13/509,185

(22) PCT Filed: Nov. 12, 2010
(86) PCT No.: PCT/DE10/01317

§ 371 Date: Jun. 20, 2012

(30) Foreign Application Priority Data
Nov. 12, 2009 (DE) 10-2009-052-667.6

(51) Int. Cl. C08G 73/02; C08L 75/04; C08G 18/08; C08F 8/32; C08G 73/06

(52) U.S. Cl. 524/591; 528/422; 525/333.7; 525/331.5; 525/333.6; 525/461; 525/535; 525/474; 528/423; 525/453

(57) ABSTRACT

The invention provides new polymeric or oligomeric active agents with a biocidal effect. Such particularly advantageous polymeric or oligomeric active agents with a biocidal effect are obtainable via polycondensation of a guanidine acid addition salt with an amine mixture comprising at least one diamine and/or one triamine, wherein at least one amine is selected from the group comprising i) diamine, comprising at least one cycloaliphatic residue, and ii) dialkylenetriamine. At least one amine is hereby preferably selected from 4,4′-methylenebis(cyclohexylamine) and diethylenetriamine. Furthermore, it is favorable if the guanidine acid addition salt is guanidinehydrochloride.

### BACKGROUND OF THE INVENTION

1. Field of the Invention

The invention relates to polymeric or oligomeric active agents with a biocidal effect, a method for their production, a composition containing these agents, a method for the production of the composition, and the use of the polymeric or oligomeric active agents and of the composition.

2. Brief Description of Related Technology

Polymers and oligomeric active agents with biocidal effect, for example polyguanidines, have been known for a long time. They are suitable to be used for a large number of applications.

U.S. Pat. No. 2,325,586 A, for example, describes the production of polyguanidines and their salts with the help of a polycondensation process. Diamines are hereby reacted with a cyanogen halide, whereby cyanamide is formed. In the subsequent polymerization, the desired polyguanidines or their salts are obtained. A particular property of such polyguanidines is their biocidal effect. EP 0 439 699 A2, for example, provides a solution comprising polymeric guanidine salts with increased biocidal effect.

In the case of such biocides (as in general with antimicrobial active agents), the quick adjustment rate of microorganisms to the corresponding active agents is problematic. The development of new antimicrobial active agents is therefore always in competition with the development of resistances of the respective target organisms. As a consequence, it is necessary to provide continuously new, effective biocides to which the microorganisms to be repressed have not adapted yet.

It is thus the aim of the invention to provide new polymeric or oligomeric active agents which have a biocidal effect. Furthermore, this active agent has to be available quickly, in large amounts (if required), and in as simple a manner as possible. Furthermore, it is therefore the aim of the invention to provide the active agents in a form which is easy to process and store. Accordingly, it is also the aim of the invention to provide a method for the production of the polymeric or oligomeric active agents, a composition comprising an active agent according to the present invention and a method to produce this composition.

### BRIEF DESCRIPTION OF THE DRAWING FIGURES

FIG. 1 is a 1H-1H COSY spectrum of an aqueous extract of a practical embodiment of a composition according to the present invention made from a thermoplastic polymer and a polymeric or oligomeric active agent according to the present invention.

FIG. 2 is a 1H-1H COSY spectrum of an aqueous extract of another practical embodiment of a composition according to the present invention made from a thermoplastic polymer and a polymeric or oligomeric active agent according to the present invention.

### DETAILED DESCRIPTION OF THE INVENTION

Disclosed herein are polymeric or oligomeric active agents with biocidal effect which are obtainable by means of the polycondensation of a guanidine acid addition salt with an amine mixture comprising at least one diamine and/or one triamine, wherein at least one amine is selected from the group comprising i) diamine, comprising at least one cycloaliphatic residue, and ii) dialkylenetriamine.

The polymeric or oligomeric active agents are hereby preferably the product of a polycondensation of a guanidine acid addition salt with an amine mixture comprising at least one diamine and/or one triamine, wherein at least one amine is selected from 4,4′-methylenebis(cyclohexylamine) and diethylenetriamine.

Both homopolymers and copolymers are hereby suitable to be obtained from the amines mentioned.

It is hereby advantageous if the guanidine acid addition salt is guanidinehydrochloride.

In a first variant of an embodiment, the polymeric or oligomeric active agent according to the present invention is a homopolymer. In this case, the amine mixtures only comprise one individual amine compound. By way of example, the polymeric or oligomeric active agent is suitable to be poly(diethylenetriamine guandine hydrochloride) (PDETAG) or poly-iminoimidazole. It is hereby advantageous if the amine mixture comprises the triamine diethylenetriamine.

The homopolymer is also suitable to be poly(4,4′-methylenebis(cyclohexylamine), wherein the amine mixture comprises the diamine 4,4′-methylenebis(cyclohexylamine).

In another embodiment variant, a polymeric or oligomeric active agent according to the present invention is a copolymer, for example a polymeric guanidine derivative. In this case, the amine mixture comprises at least two different amines. In other words, the amine mixture comprises one first component and at least one second component. The first component is a diamine or a triamine selected from the group comprising diamine, which comprises at least one cycloaliphatic residue, and dialkylenetriamine. The second component is a diamine or triamine selected from the group consisting of diamine, which comprises at least one cycloaliphatic residue, dialkylenetriamine, alkylenediamine and oxyalkylenediamine. The first component is different from the second component.

Particularly preferred copolymers result from the combinations of 4,4′-methylenebis(cyclohexylamine) with an amine from the group comprising diethylenetriamine, hexamethylenediamine, triethyleneglycoldiamine, and from the combinations of diethylenetriamine with hexamethylenediamine or triethyleneglycoldiamine.

It is therefore favorable according to the present invention if the first component is a diamine or a triamine selected from the group 4,4′-methylenebis(cyclohexylamine), diethylenetriamine; the second component is also a diamine or a triamine selected from the group 4,4′-methylenebis(cyclohexylamine), diethylenetriamine, hexamethylenediamine, triethyleneglycoldiamine; the first component is different from the second component.

It is recognizable that the first component in a polymeric or oligomeric active agent according to the present invention in a first preferred copolymeric embodiment is 4,4′-methylenebis(cyclohexylamine) and the second component is selected from diethylenetriamine, hexamethylenediamine, triethyleneglycoldiamine.

In a second preferred copolymeric embodiment, the first component is diethylenetriamine and the second component is selected from hexamethylenediamine and triethyleneglycoldiamine.

It is generally well known that the mixing ratio of the starting monomers in particular plays an essential role in the production of copolymers. For embodiments of the polymeric or oligomeric active agents according to the present invention which are copolymers, it has proven to be particularly favorable if the monomers are available in an equimolar ratio up to and including a fourfold excess of one of the two monomers. This means that the first component and the second component are available in a molar ratio of 4:1 to 1:4, preferably from 2:1 to 1:2.

It is also favorable if the amine mixture and the guanidine salt are used in an equimolar manner to one another.

The embodiments of the polymeric or oligomeric active agent obtained under these conditions all comprise an antibacterial effect which is suitable to be described by means of the so-called minimum inhibitory concentration. This concentration specifies the lowest bactericidal concentration that will inhibit the growth of bacteria in a certain solution. A minimum inhibitory concentration of less than 50 μg/ml is hereby particularly favorable. For many of the practical embodiments involving polymeric guanidine derivatives, the minimum inhibitory concentration is even considerably lower and amounts to less than 10 μg/ml or even less than 5 μg/ml. The lower the concentration, the more effectively the corresponding active agent is suitable to be utilized as a biocide.

For the continued effective use as a biocide, a particularly favorable property of the polymeric or oligomeric active agents according to the present invention is therefore that its minimum inhibitory concentration amounts to 50 μg/ml or less, preferably less than 30 μg/ml, particularly preferably 10 μg/ml or less and very particularly preferably less than 5 μg/ml.

Another advantage of the polymeric or oligomeric active agents according to the present invention is the relatively simple method of production. It comprises the following steps:
Placing one equivalent of guanidinehydrochloride
Adding one equivalent of the amine mixture
Heating to 140° C. to 180° C., preferably 145° C. to 175° C., particularly preferably 150° C. to 170° C.
Stirring the melt at between 140° C. and 180° C., preferably between 145° C. and 175° C., particularly preferably between 150° C. and 170° C. until the gas formation is completed, but for at least 5 hours.

Such a method is also easily and practically suitable to be implemented on an industrial scale. As such, the polymeric or oligomeric active agents according to the present invention are commercially producible on a large scale without any particular effort.

The method varies slightly according to the desired end product, for example the production of a homopolymer based on 4,4′-methylenebis(cyclohexylamine) is favorable when the reaction temperature, by way of example, amounts to 170° C. In contrast, a homopolymer produced on the basis of diethylenetriamine is suitable to be obtained at a temperature of 150° C. The production of the copolymers according to the present invention, on the other hand, preferably takes place at 170° C.

For these reaction conditions mentioned, it was observed as a complete surprise that, for example, not only polymeric guanidine structures, but also cyclic structures, namely iminoimidazole structures, were formed within the monomer units in the condensation of triamines, meaning that the embodiments of the polymeric or oligomeric active agent according to the present invention are not just polymeric guanidine derivatives, but also poly-iminoimidazole.

In addition to the polymeric or oligomeric active agents and the method for their production according to the present invention, the invention also provides a composition comprising at least one polymeric or oligomeric active agent according to the present invention, wherein the composition is a plastic granule.

The provision of such a plastic granule is advantageous in many respects. As such, it is not just easy to store, but also easy to dose and equally quick and easy to process. By way of example, it is suitable to be used to produce plastic objects which have a corresponding biocidal effect due to the active agent contained within. Such articles are suitable to play a highly advantageous role in many areas of daily life, such as (sewage) water pipes, furniture, handles, sanitary items, shower curtains, sealant material, food packaging, food-pouring and food-discharge items, food processing machines, flooring, cleaning cloths, cleaning fluids, agricultural and feeding installations, animal blankets, carpets, shoe soles, teeth-cleaning items, drinking vessels, keyboards or other input devices and operating elements, telephony equipment, and antibacterial paint. A multitude of other items is naturally conceivable, such as apparel fabrics, functional textiles, antibacterial papers, technical filters, packaging materials for cosmetics and/or articles of daily use in the medical sector.

It is accordingly favorable if the composition also comprises at least one plastic, preferably at least one thermoplastic polymer, in particular selected from polyurethane, polyolefin, polyvinylchloride, polypropylene, polycarbonate, polystyrene, polyethersulfone, silicon and polyamide. Other polymers suitable to be selected according to the desired special use are naturally also conceivable.

It is hereby also particularly advantageous if the composition of the polymeric or oligomeric active agent is covalently bonded to the plastic, wherein the plastic is preferably a thermoplastic polymer which is preferably a thermoplastic polymer selected from the group consisting of thermoplastic aliphatic and aliphatic/aromatic polyurethanes, aliphatic and aliphatic/aromatic polyesters, aliphatic and aliphatic/aromatic polyamides, aliphatic and aliphatic/aromatic polycarbonates, aliphatic and aliphatic/aromatic polyureas, aliphatic and aliphatic/aromatic polyesteramides and wherein the polymeric or oligomeric active agent comprises cyclic structures in the main chain.

It has also been shown that such compositions which are available as hydroxide salt comprise particularly good biocidal effectiveness. They are suitable, by way of example, to be obtained from the corresponding halides e.g. chlorides via basic anion replacement.

It is furthermore particularly advantageous if the polymeric or oligomeric active agent comprises a structure that is selected from the group comprising

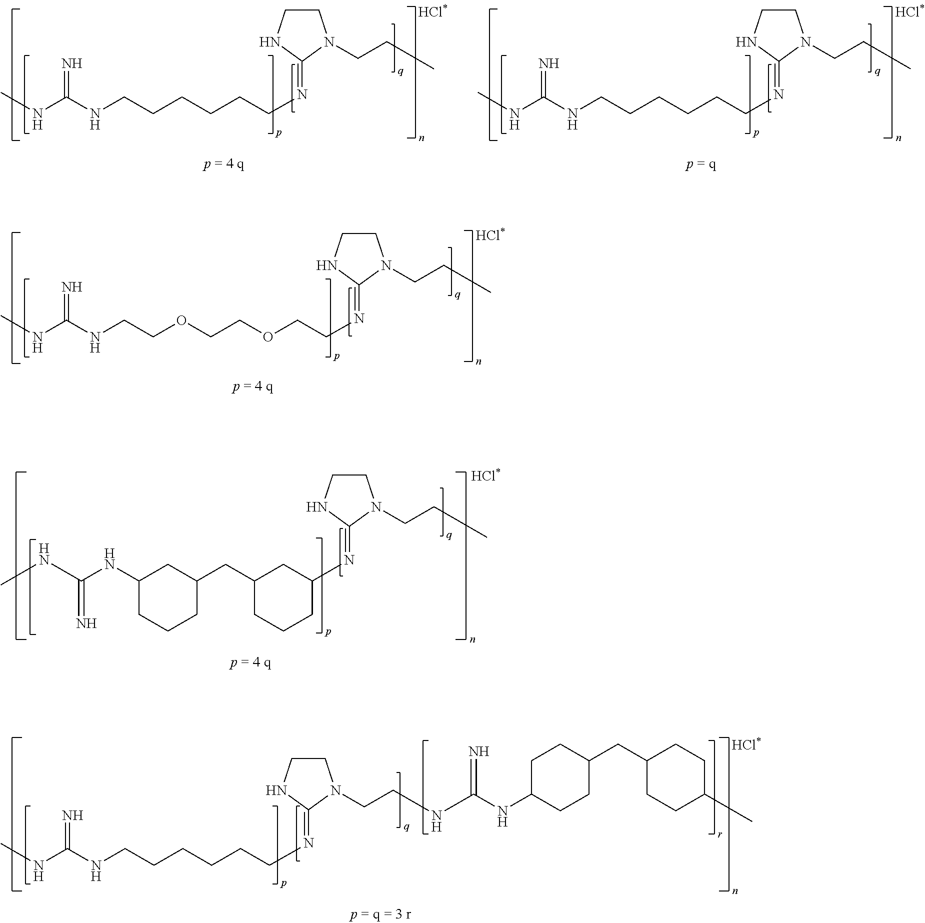

HCl* hereby means that the HCl is not covalently bonded,
n is a natural number, preferably from 1 to 20, more preferably from 2 to 16 and in particular from 3 to 8, and
p, q and r are integers which define the preferred molar ratio of the structure fragments to one another in the formulas.

A composition comprising at least one polymeric or oligomeric active agent is particularly advantageous, and is obtainable via the reaction of (a) a polymeric or oligomeric active agent having a biocidal effect, which is obtainable via the polycondensation of a guanidine acid addition salt with an amine mixture comprising at least a diamine and/or a triamine, wherein at least one amine is selected from the group consisting of i) diamine, comprising at least one cycloaliphatic residue, and ii) dialkylenetriamine with (b) a plastic, wherein the polymeric or oligomeric active agent is covalently bonded to the plastic.

For the production of a composition, in which the polymeric or oligomeric active agent is covalently bonded to the plastic, a copolymer is formed from the components mixed during the compounding using the polymeric or oligomeric active agents according to the present invention. This occurs in particular when the thermoplastic polymer is a thermoplastic aliphatic polyurethane (TAPU) or a thermoplastic aliphatic/aromatic polyurethane (TAAPU) and if the polymeric or oligomeric active agent comprises a cyclic structure which is selected from the group consisting of

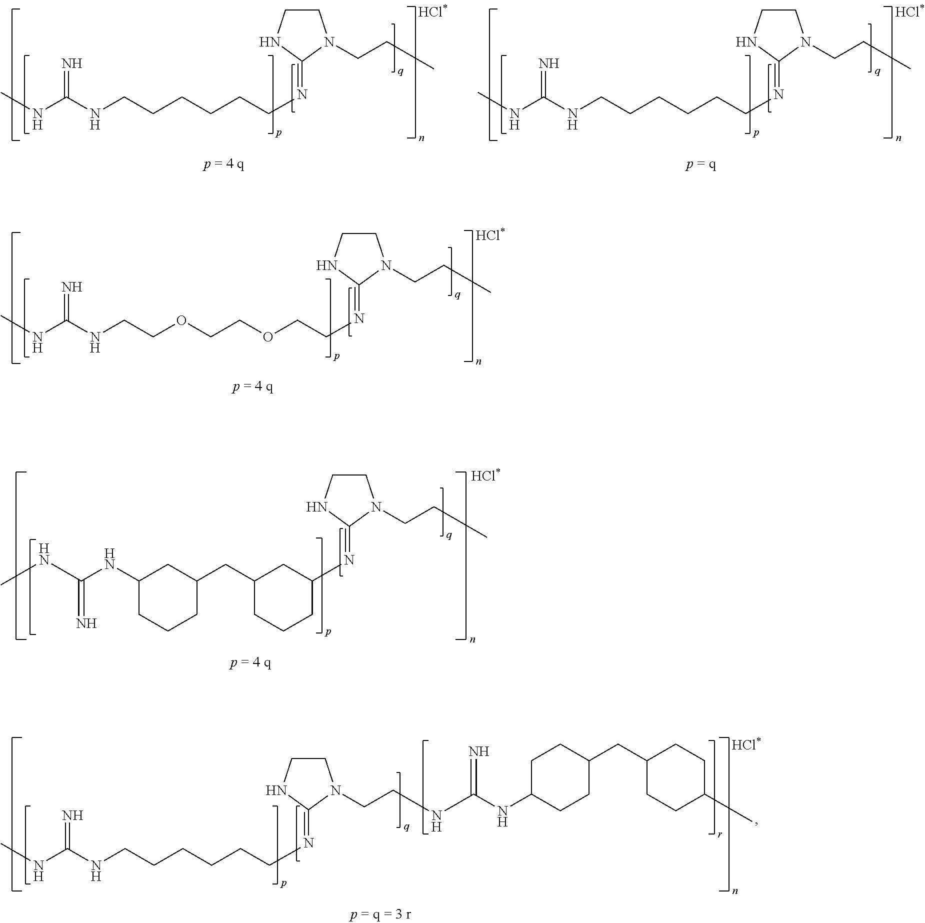

wherein HCl* hereby also means that the HCl is not covalently bonded,
n is a natural number, preferably from 1 to 20, more preferably from 2 to 16 and in particular from 3 to 8, and
p, q and r are integers which define the preferred molar ratio of the structure fragments to one another in the formulas.

For the production of such a composition, a copolymer is also formed in particular from the components mixed during the compounding when the production is carried out under conditions according to which a so-called ‘reactive processing’ takes place. For this, the polymeric or oligomeric active agent is mixed with the thermoplastic polymer, and the reaction conditions are chosen in such a way that the polymeric or oligomeric active agent is covalently bonded to the thermoplastic polymer. This may occur, by way of example, by selecting the thermoplastic polymer in such a way that it still carries reactive groups such as isocyanate groups.

However, the bonding is also suitable to take place under selected conditions as part of re-condensation. Particularly suitable thermoplastic polymers for this are aliphatic polyurethanes and/or aromatic and/or araliphatic polyurethanes. The polymeric or oligomeric active agent is preferably reacted in liquid form, preferably dissolved in a solvent, with the thermoplastic polymer. It has surprisingly been shown that covalent bonding easily occurs under these conditions in particular. Suitable solvents are, for example, polar solvents such as alcohol; however, water is also extremely suitable.

It is furthermore favorable if the thermoplastic polymer is extruded at a mass temperature of more than 120° C., preferably more than 140° C., particularly preferably more than 160° C., very particularly preferably between 160° C. and 300° C. and very particularly preferably at 170° C., and if the thermoplastic polymer is additivated with a 0.1 to 90 wt. % aqueous solution, preferably a 20 to 80 wt. % aqueous solution, particularly preferably a 30 to 50 wt. % aqueous solution and very particularly preferably a 40 wt. % aqueous solution of the polymeric or oligomeric active agent.

Under these reaction conditions in particular, the covalent bonding of the polymeric or oligomeric active agents according to the present invention to the thermoplastic polymer of the plastic granule composition is observed. This substance according to the present invention is also suitable to be highly advantageously used for diverse applications of substances with a biocidal effect. In particular, such a plastic granule, for which the polymeric or oligomeric active agent is covalently bonded to the plastic, comprises a biocidal effect. A particular advantage of this plastic granules, for which the polymeric or oligomeric active agent is covalently bonded to the thermoplastic polymer, lies in the fact that the so-called leaching of the biocidal active agents is considerably reduced when brought into contact with water or, for example, bodily fluid.

The plastic granule according to the present invention is suitable to be provided in the form of a master batch. This is then diluted again prior to its corresponding use. It is hereby of no consequence if the plastic granule is a physical mixture of the polymeric or oligomeric active agent according to the present invention or if the polymeric or oligomeric active agent is covalently bonded to the thermoplastic polymer.

As for the polymeric or oligomeric active agents according to the present invention themselves, another advantage of the invention is that the plastic granule according to the present invention is suitable to be produced very quickly and easily. A method for the production of a plastic granule comprises the following steps: (a) combination and mixing of a polymeric or oligomeric active agent with a biocidal effect according to the present invention with a thermoplastic polymer; and, (b) granulating the mixture created via step a).

The polymeric or oligomeric active agent is hereby added, preferably in liquid form, to the thermoplastic polymer, and the mixing in step (a) takes place in an extruder. The thermoplastic polymer is selected from the group consisting of polyurethane, polyolefin, polyvinylchloride, polypropylene, polycarbonate, polystyrene, polyethersulfone, silicon and polyamide.

It is recognizable that the polymeric guanidine derivatives according to the present invention are suitable to be advantageously used to produce apparel fabrics, functional textiles, antibacterial papers, technical filters, packaging materials for food and cosmetics and/or articles of daily use in the medical sector.

By way of example, lab coats, gloves, hoods or shoes that are suitable to be used in laboratories or clinically sterile areas and functional textiles such as face masks, surgery blankets and bedding are therefore suitable to be produced using the polymeric or oligomeric active agents according to the present invention or a plastic granule according to the present invention. Cleaning cloths, sterile filters, air filters, the surface of furniture or trays, and curtains in the hospital sector are also suitable to be advantageously produced at least partially using the active agents according to the present invention. Their use for the production of packaging materials for food or cosmetics is also advantageous. In particular, the polymeric or ologomeric active agents according to the present invention are advantageously suitable for the production of (sewage) water pipes, furniture, handles, sanitary items, shower curtains, sealant material, food packaging, food-pouring and food-discharge items, food processing machines, flooring, cleaning cloths, cleaning fluids, agricultural and feeding installations, animal blankets, carpets, shoe soles, teeth-cleaning items, drinking vessels, keyboards or other input devices and operating elements, telephony equipment, and antibacterial paint.

The same applies for the use of a composition according to the present invention for the production of apparel fabrics, functional textiles, antibacterial papers, technical filters, packaging materials for food and cosmetics and/or articles of daily use in the medical sector.

Further characteristics, details and advantages of the invention result from the text of the claims and in the following description of practical embodiments.

### Embodiment 1

### Synthesis of poly(4,4′-methylenebis(cyclohexylamine)guanidinehydrochloride) (PMBCG)

In a three-necked 100 ml flask preheated three times, 1 equivalent (8.12 g, 85 mmol) of guanidinehydrochloride is added to the argon countercurrent. In the glovebox, 1 equivalent (17.88 g, 85 mmol) of 4,4′ methylene(cyclohexylamine) is subsequently added.

The flask is equipped with an inner thermometer and a reflux condenser pre-heated three times with a non-return valve according to Stutz (hereinafter Stutz cooler).

The reaction mixture is heated in an oil bath, wherein gas slowly starts to form from a temperature of 100° C. onwards. When the temperature is further increased, the formation of gas only increases slowly. After a total of 85 minutes a temperature of 170° C. is achieved.

This temperature is maintained for 9 hours until the gas formation is ended according to visual inspection.

The melt is cooled to room temperature under ice cooling and oil pump vacuum.

The initial quantities yield 24.48 g of a transparent, colorless and brittle solid under the conditions mentioned above.

The structure of the polymer obtained is suitably represented according to formula (I).

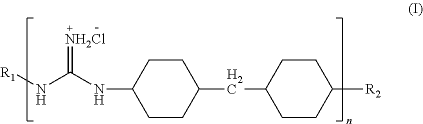

In Formula (I), n is 1 to 8, predominantly 1 to 3. The residues R₁ and R₂ are suitable to be derived both from the monomer used and from the guanidinehydrochloride used, and are therefore defined as follows:

wherein R₁ is selected from H or

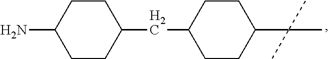

and
R₂ is selected from NH₂ or

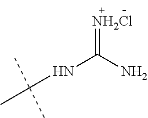

The resulting product mixture therefore comprises polymeric compounds according to formulas (II), (III) and (IV):

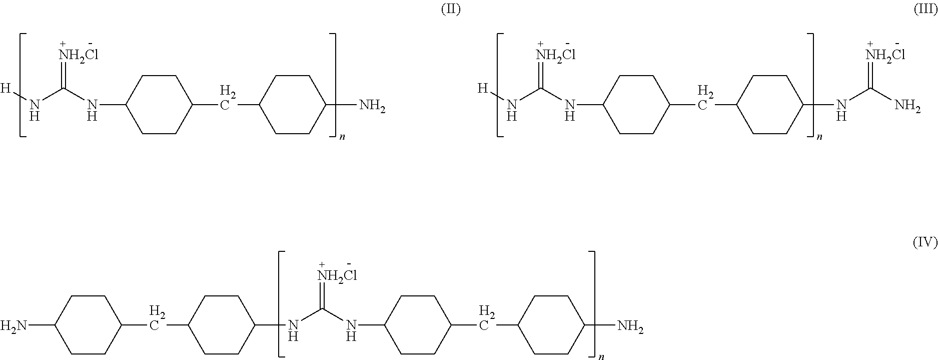

The formulas (I), (II), (III) and (IV) are suitably represented alternatively, as shown below, by way of example, for formulas (VIII) and (VIII′), respectively. The positive charge of the guanidine unit is hereby not localized, but is mesomerically distributed across all three nitrogen atoms.

### Embodiment 2

### Synthesis of poly(diethylenetriamineguanidinehydrochloride) (PDETAG)

In a three-necked 100 ml flask preheated three times and filled with argon, with an inner thermometer, Stutz cooler and an extraction element with tap, 1 equivalent (8.12 g, 85 mmol) of guanidinehydrochloride and 1 equivalent (8.77 g, 85 mmol) of diethylenetriamine are heated to a temperature of 150° C. within 50 minutes with the help of an oil bath.

Upon achieving a temperature of 95° C., a formation of gas is suitable to be observed which rapidly increases when the temperature is further increased.

The melt is maintained under stirring for five hours at 150° C. until the gas formation is ended.

The melt is cooled to room temperature under ice cooling and oil vacuum.

The initial quantities yield 11.96 g of a white and brittle solid under the conditions mentioned above.

The repetitive monomer unit of the resulting polymeric active agent surprisingly shows the cyclic structure according to formula (V):

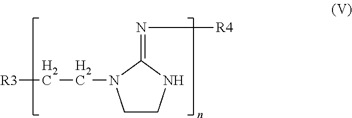

In Formula, (V) n is 1 to 12, predominantly 2 to 8.
R3 is either NH₂ or

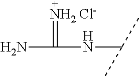

and
R4 is selected from

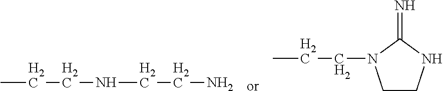

The resulting product mixture therefore comprises polymeric compounds according to formulas (VI), (VII) and (VIII):

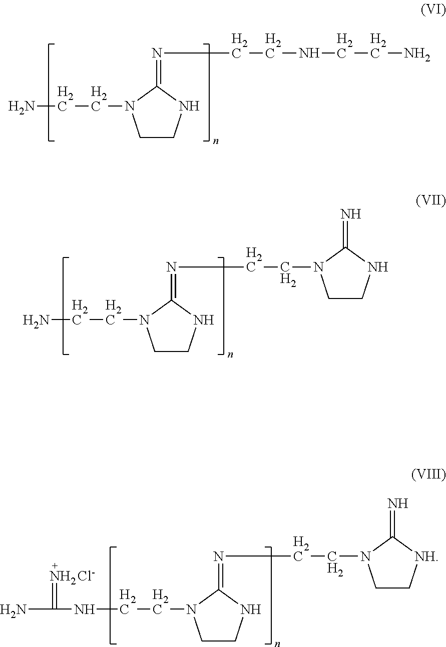

It is hereby conceivable that approximately 90% of the rings in the formulas (VI), (VII) and (VIII) carry a positive charge. It is hereby also conceivable that the positive charge is not localized to one of the nitrogen atoms in the ring, but is in fact delocalized. An alternative representation form of the formula (VIII) is therefore the following formula (VIII′)

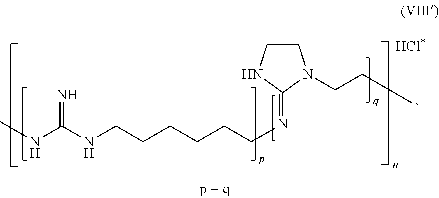

wherein
HCl* means that the HCl is not covalently bonded,
n is a natural number which has the aforementioned meaning, and
p and q are integers which define the preferred molar ratio of the structure fragments to one another in the formulas.

The formulas (I) to (IV) of the embodiment 2 are also suitable to be represented in an analogous manner, wherein the positive charge is mesomerically distributed across all three nitrogen atoms of the guanidine unit.

### Embodiment 3

### Synthesis of Guanidine Copolymers According to the Present Invention

In a reaction flask prepared according to the previously described embodiments, 1 equivalent (8.12 g, 85 mmol) of guanidinehydrochloride and 1 equivalent of the of the comonomers available in a mixing ratio according to Table 1, respectively, are jointly heated to a temperature of 170° C. within 30 minutes with the help of an oil bath.

The melt is maintained under stirring for five hours at this temperature. The melt is cooled to room temperature under ice cooling and oil vacuum.

TABLE 1
Mixing ratio of the diamines and triamines used in the amine mixture for the
production of guanidine copolymers (eq = equivalent).

| | | | Amount | | Amount | |
|---|---|---|---|---|---|---|
| | | | of | | of | |
| | | | monomer | | monomer | |
| No. | Monomer 1 | Monomer 2 | 1 used | | 2 used | |
| C1 | 4,4′-methylenebis(cyclohexylamine) | diethylenetriamine | 14.30 | g | 2.21 | g |
| | | | 68 | mmol | 17 | mmol |
| | | | 0.80 | aq | 0.2 | aq |
| C2 | 4,4′-methylenebis(cyclohexylamine) | diethylenetriamine | 13.41 | g | 2.77 | g |
| | | | 63.75 | mmol | 21.25 | mmol |
| | | | 0.75 | aq | 0.25 | aq |
| C3 | 4,4′-methylenebis(cyclohexylamine) | diethylenetriamine | 11.92 | g | 3.69 | g |
| | | | 56.67 | mmol | 28.33 | mmol |
| | | | 0.67 | aq | 0.33 | aq |
| C4 | 4,4′-methylenebis(cyclohexylamine) | diethylenetriamine | 8.94 | g | 5.53 | g |
| | | | 42.50 | mmol | 42.50 | mmol |
| | | | 0.50 | aq | 0.50 | aq |
| C5 | 4,4′-methylenebis(cyclohexylamine) | hexamethylenediamine | 3.58 | g | 7.90 | g |
| | | | 17.00 | mmol | 68.00 | mmol |
| | | | 0.20 | aq | 0.80 | aq |
| C6 | 4,4′-methylenebis(cyclohexylamine) | hexamethylenediamine | 4.47 | g | 7.41 | g |
| | | | 21.25 | mmol | 63.75 | mmol |
| | | | 0.25 | aq | 0.75 | aq |
| C7 | 4,4′-methylenebis(cyclohexylamine) | hexamethylenediamine | 5.96 | g | 6.59 | g |
| | | | 28.33 | mmol | 56.67 | mmol |
| | | | 0.33 | aq | 0.67 | aq |
| C8 | 4,4′-methylenebis(cyclohexylamine) | hexamethylenediamine | 8.94 | g | 4.94 | g |
| | | | 42.50 | mmol | 42.50 | mmol |
| | | | 0.50 | aq | 0.50 | aq |
| C9 | 4,4′-methylenebis(cyclohexylamine) | hexamethylenediamine | 11.92 | g | 3.29 | g |
| | | | 56.67 | mmol | 28.33 | mmol |
| | | | 0.67 | aq | 0.33 | aq |
| C10 | 4,4′-methylenebis(cyclohexylamine) | hexamethylenediamine | 13.41 | g | 2.47 | g |
| | | | 63.75 | mmol | 21.25 | mmol |
| | | | 0.75 | aq | 0.25 | aq |
| C11 | 4,4′-methylenebis(cyclohexylamine) | hexamethylenediamine | 14.30 | g | 1.98 | g |
| | | | 68.00 | mmol | 17.00 | mmol |
| | | | 0.80 | aq | 0.20 | aq |
| C12 | 4,4′-methylenebis(cyclohexylamine) | triethyleneglycoldiamine | 13.41 | g | 3.15 | g |
| | | | 63.75 | mmol | 21.25 | mmol |
| | | | 0.75 | aq | 0.25 | aq |
| C13 | 4,4′-methylenebis(cyclohexylamine) | triethyleneglycoldiamine | 11.92 | g | 4.20 | g |
| | | | 56.67 | mmol | 28.33 | mmol |
| | | | 0.67 | aq | 0.33 | eq |
| C14 | 4,4′-methylenebis(cyclohexylamine) | triethyleneglycoldiamine | 8.94 | g | 6.30 | g |
| | | | 42.50 | mmol | 42.50 | mmol |
| | | | 0.50 | aq | 0.50 | aq |
| C15 | 4,4′-methylenebis(cyclohexylamine) | triethyleneglycoldiamine | 5.96 | g | 8.40 | g |
| | | | 28.33 | mmol | 56.67 | mmol |
| | | | 0.33 | aq | 0.67 | aq |
| C16 | 4,4′-methylenebis(cyclohexylamine) | triethyleneglycoldiamine | 4.47 | g | 9.45 | g |
| | | | 21.25 | mmol | 63.75 | mmol |
| | | | 0.25 | aq | 0.75 | eq |
| C17 | diethylenetriamine | hexamethylenediamine | 1.75 | g | 7.90 | g |
| | | | 17.00 | mmol | 68.00 | mmol |
| | | | 0.20 | aq | 0.80 | aq |
| C18 | diethylenetriamine | hexamethylenediamine | 2.19 | g | 7.41 | g |
| | | | 21.25 | mmol | 63.75 | mmol |
| | | | 0.25 | aq | 0.75 | aq |
| C19 | diethylenetriamine | hexamethylenediamine | 3.69 | g | 6.59 | g |
| | | | 28.33 | mmol | 56.67 | mmol |
| | | | 0.33 | aq | 0.67 | aq |
| C20 | diethylenetriamine | hexamethylenediamine | 5.53 | g | 4.94 | g |
| | | | 42.50 | mmol | 42.50 | mmol |
| | | | 0.50 | aq | 0.50 | aq |
| C21 | diethylenetriamine | triethyleneglycoldiamine | 8.30 | g | 3.15 | g |
| | | | 63.75 | mmol | 21.35 | mmol |
| | | | 0.75 | aq | 0.25 | aq |
| C22 | diethylenetriamine | triethyleneglycoldiamine | 7.38 | g | 4.20 | g |
| | | | 56.67 | mmol | 28.33 | mmol |
| | | | 0.67 | aq | 0.33 | aq |
| C23 | diethylenetriamine | triethyleneglycoldiamine | 5.53 | g | 6.30 | g |
| | | | 42.50 | mmol | 42.50 | mmol |
| | | | 0.50 | aq | 0.50 | aq |

It is recognizable that the mixing ratio of the two monomers comprised in the amine mixture is between 1:1 and 1:4 and between 4:1 and 1:1, respectively.

### Embodiment 4

### Determination of the Minimum Inhibitory Concentration

In order control the biocidal effect of the polymeric or oligomeric active agents according to the present invention, the compounds produced according to one of the previous embodiments are cultured in a bacterial culture medium, preferably Tryptic Soy Broth, and diluted to different concentrations. These solvents of different concentrations are inoculated with a suspension of Escherichia coli and incubated for 24 hours (h) at 37° C.

The lowest concentration of the biocide in the solvent to be examined at which the growth of the bacteria is inhibited is subsequently understood under the minimum inhibitory concentration (MIC). At the respective solution, no turbidity is suitable to be observed due to the growth of the bacteria.

For the homopolymers represented in embodiments 1 and 2 according to formula (I) and formula (V) and for the copolymers obtained from the comonomer mixtures C1 to C23 mentioned in embodiment 3, the average minimum inhibitory concentrations (MIC) are obtained in Table 2.

TABLE 2
Determination of the minimum inhibitory concentration of polymeric
guanidine derivatives according to the present invention
(MIC = minimum inhibitory concentration)

| Compound | MIC [μg/ml] |
|---|---|
| Control polymer | 5 |
| According to | 5 |
| formula (I) | |
| According to | >250 |
| formula (V) | |
| C1 | 7.5 |
| C2 | 22.5 |
| C3 | 25 |
| C4 | 50 |
| C5 | 1.5 |
| C6 | 4.7 |
| C7 | 4.25 |
| C8 | 2.5 |
| C9 | 3.5 |
| C10 | 2.5 |
| C11 | 9.75 |
| C12 | 5.5 |
| C13 | 8.5 |
| C14 | 10 |
| C15 | 10 |
| C16 | 10 |
| C17 | 3 |
| C18 | 10 |
| C19 | 10 |
| C20 | 40 |
| C21 | >50 |
| C22 | >50 |
| C23 | >50 |

A control polymer whose biocidel effect is known and whose minimum inhibitory concentration normally lies at 5 μg/ml was used as a control.

It is recognizable that all polymeric or oligomeric active agents according to the present invention, in particular the copolymers according to the present invention which are polymeric guanidine derivatives, comprise a biocidal effect. In particular, copolymers which comprise hexamethylenediamine as a second monomer comprise a minimum inhibitory concentration which is even lower than 5 μg/ml:

TABLE 3
Selected copolymers according to the present invention with a
particularly low minimum inhibitory concentration (MHK).

| | | | Mixture | Reaction | |
|---|---|---|---|---|---|
| Copolymer | Monomer 1 | Monomer 2 | ratio | conditions | MHK |
| C5 | MBC | HMD | 1:4 | 5 h, 170° C. | 1.5 |
| C6 | MBC | HMD | 1:3 | 5 h, 170° C. | 4.7 |
| C7 | MBC | HMD | 1:2 | 5 h, 170° C. | 4.25 |
| C8 | MBC | HMD | 1:1 | 5 h, 170° C. | 2.5 |
| C9 | MBC | HMD | 2:1 | 5 h, 170° C. | 3.5 |
| C10 | MBC | HMD | 3:1 | 5 h, 170° C. | 2.5 |
| C17 | DETA | HMD | 1:4 | 5 h, 170° C. | 3 |

(MBC = 4,4′-methylenebis(cyclohexylamine), HMD = hexamethylenediamine, DETA = diethylenetriamine)

### Embodiment 5

### Plastic Granules with a Polymeric or Oligomeric Active Agent Covalently Bonded to a Thermoplastic Polymer

During the compounding of polymeric or oligomeric active agents according to the present invention in thermoplastic polymers, e.g. as polyurethanes, a so-called reactive processing occurs under certain conditions. The polymeric or oligomeric active agents are hereby covalently bonded to the thermoplastics used.

In a respective production method, aqueous solutions of biocidal polycondensates, namely the polymeric or oligomeric active agents according to the present invention, are co-extruded with melts of thermoplastic polycondensates or polyaddition products. New thermoplastics (biocidal thermoplastics) are hereby formed by means of re-condensation.

Polycondensates or polyaddition products are used as initial thermoplastics, which are suitable to be processed by means of melt extrusion, e.g. polyesters such as polyethylene terephtalate, polybutylene terephtalate, polyactide; polyamides as e.g. polyamide (PA) 6, PA 66, PA 610, PA11, PA12, polyester amides, aliphatic and aromatic polycarbonates, aliphatic and aromatic polyurethanes and polyureas.

Water-soluble polyguanidines (PG) are used as polymeric or oligomeric active agents, which are, in particular, those with the following structures:

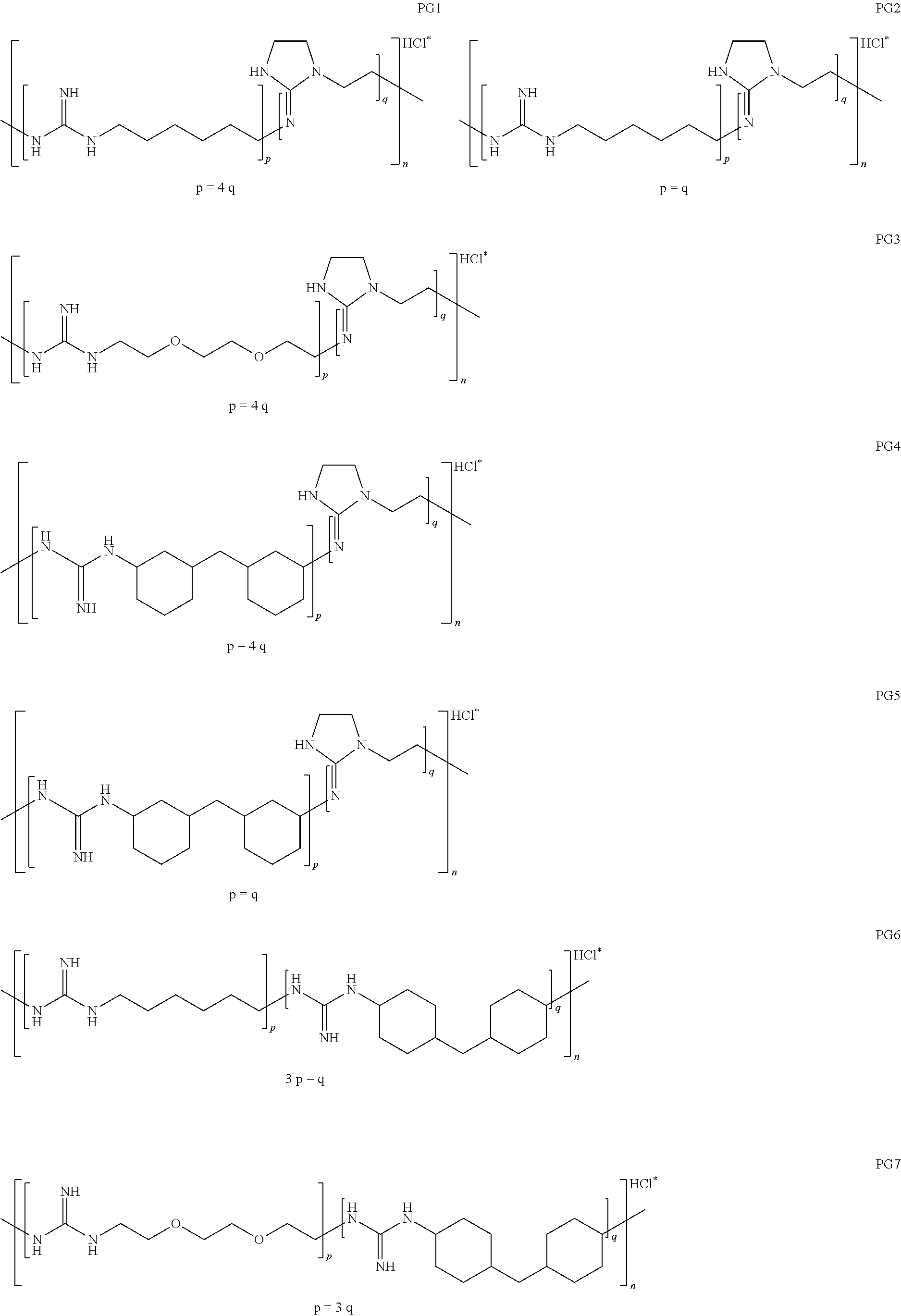

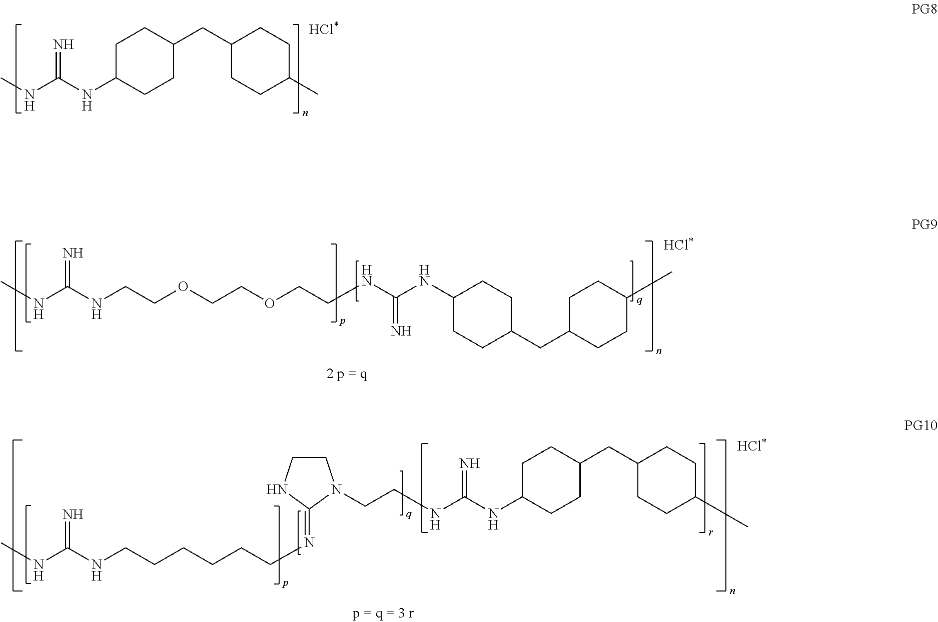

wherein
HCl* means that the HCl is not covalently bonded,
n is a natural number, preferably from 1 to 20, more preferably from 2 to 16 and in particular from 3 to 8, and
p, q and r are integers which define the preferred molar ratio of the structure fragments to one another in the formulas.

For the production of the biocidal plastic granules, the thermoplastic in melt extrusion is additivated in a conventional extruder at extrusion temperatures of 70-300° C., depending on the thermoplastic with an aqueous solution of the biocidal polymeric or oligomeric active agent with concentrations of 0.1-90 wt. % of the biocidal polymeric or oligomeric active agent in water.

The water is removed in the evaporation zone of the extruder. At the end of the extrusion, the biocidal thermoplastic is obtained as a new product which comprises 0.1-50% of the structures of the polymeric or oligomeric active agents relative to the thermoplastics used. The polymeric or oligomeric active agents are hereby covalently bonded to the thermoplastics by means of re-condensation. The re-condensation takes place during the extrusion.

Confirmation that the polymeric or oligomeric active agents are covalently bonded after extrusion to the thermoplastic polymer used is suitable to be carried out both by means of NMR and via mass spectrometry.

In a first practical embodiment for the plastic granules according to the present invention with a polymeric or oligomeric active agent covalently bonded to a thermoplastic polymer, thermoplastic aliphatic polyurethane (TAPU) is extruded at a mass temperature of 170° C. in a twin-screw extruder and additivated with an aqueous solution of 40% of a first polyguanidine (PG1) which comprises the following structure:

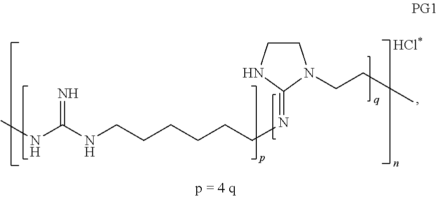

wherein
HCl* means that the HCl is not covalently bonded,
n is a natural number which has the aforementioned meaning, and
p and q are integers which define the preferred molar ratio of the structure fragments to one another in the formulas.

The additivation hereby occurs in such a way that a compound with 10 wt. % of the first polyguanidine (PG1) in TAPU is formed.

The mass spectroscopic analysis shows that after extraction of the compound, no active agent according to the present invention, namely no first polyguanidine (PG1), is suitable to be found in the extract. The extraction was hereby carried out with boiling water.

In a second practical embodiment, a thermoplastic aliphatic/aromatic polyurethane (TAAPU) is used as a thermoplastic polymer instead of the thermoplastic aliphatic polyurethane (TAPU). The extrusion also occurred here at a mass temperature of 170° C. in the twin-screw extruder under additivation of a 40% aqueous solution of the first polyguanidine (PG1).

As before, pure PG1 is not suitable to be detected in the extract here; this shows the covalent bonding of PG1 to the thermoplastic aliphatic/aromatic polyurethane.

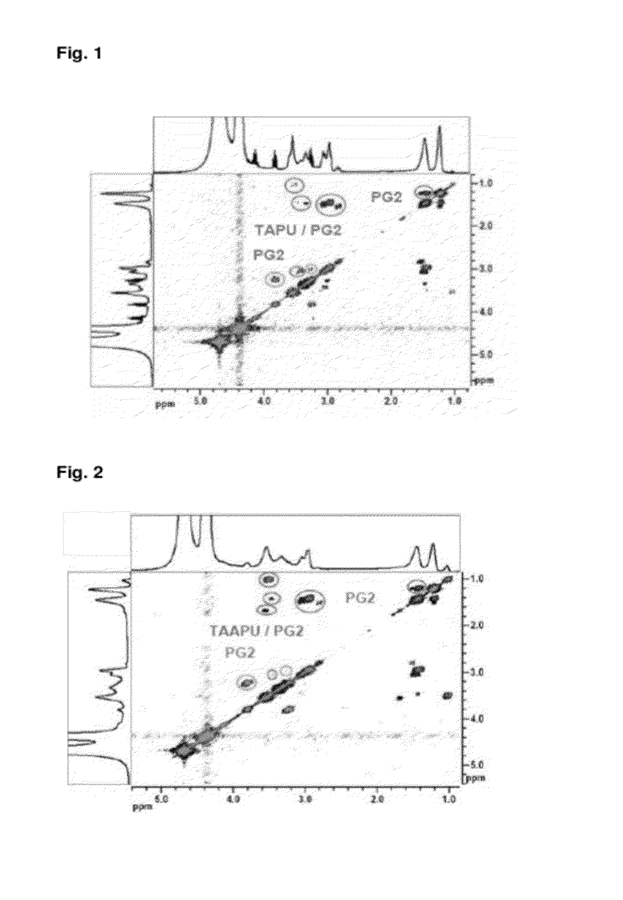

In FIG. 1, covalent bonding is also suitable to be clearly recognized in the two dimensional NMR spectrum for a third practical embodiment. As before, in this embodiment the thermoplastic aliphatic polyurethane (TAPU) was extruded in the twin-screw extruder at a mass temperature of 170° C. and additivated with a 40% aqueous solution of a second polyguanidine (PG2). The second polyguanidine (PG2) hereby comprises the following structure:

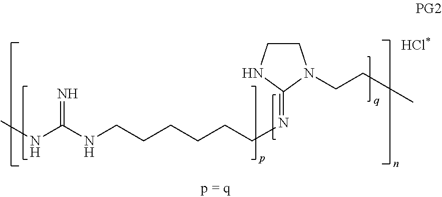

wherein
HCl* means that the HCl is not covalently bonded,
n is a natural number, which has the aforementioned meaning, and
p and q are integers which define the preferred molar ratio of the structure fragments to one another in the formulas.

A compound with 10 wt. % of the second polyguanidine (PG2) in TAPU is formed. FIG. 1 hereby shows the 1H-1H COSY spectrum of the extract of the embodiment.

For a fourth embodiment, FIG. 2 also shows the 1H-1H COSY spectrum of the extract. Instead of the thermoplastic aliphatic polyurethane (TAPU), a thermoplastic aliphatic/aromatic polyurethane was used and extruded as before with a 40% aqueous solution of the second polyguanidine (PG2) at a mass temperature of 170° C. The additivation occurred in such a way that a compound with 10 wt. % of the second polyguanidine (PG2) in TAPU is formed. As before, a polymeric or oligomeric active agent, namely a second polyguanidine (PG2), is not suitable to be determined here in the extract with boiling water.

### Experimental Conditions for 1H-1H-COSY NMR:

1H-1H-COSY NMR were measured on the Bruker Avance 300 B spectrometer (dual 1H-13C sample head with Z-gradient) at 25%, respectively, in a solvent mixture of hexafluoroisopropanole (ca. 1 mL) and D2O (approx. 0.2 mL). Calibration took place on the protonated D2O peak as the internal standard (4.79 ppm at 25° C.). (The 2D spectra presented in the report are not calibrated, because the 1D spectrum on the top left would thereby be moved.)

### Experimental Conditions of Mass Spectroscopy:

The mass spectra were measured by means of chemical ionization at atmospheric pressure (atmospheric pressure chemical ionization, APCI) on a Thermo Fisher Scientific Finnigan LTO-FT spectrometer in methanol as a solvent.

The invention is not limited to one of the previously described practical embodiments; rather, it is suitable for being modified in all kinds of ways.

It is recognizable that particularly advantageous polymeric or oligomeric active agents with a biocidal effect are obtainable via the polycondensation of a guanidine acid accidition salt with an amine mixture comprising at least one diamine and/or one triamine, wherein at least one amine is selected from the group group comprising i) diamine, comprising at least one cycloaliphatic residue, and ii) dialkylenetriamine. At least one amine is hereby preferably selected from 4,4′-methylenebis(cyclohexylamine) and diethylenetriamine. Furthermore, it is favorable if the guanidine acid addition salt is guanidinehydrochloride.

It is also advantageous if the amine mixture comprises an alkylenediamine, in particular a compound of the general formula NH2(CH2)nNH2, in which n is an integer between 2 and 10, in particular 6, or if the amine mixture comprises an oxyalkylenediamine, in particular a compound of the general formula NH2[(CH2)2O]n(CH2)2NH2, in which n is an integer between 2 and 5, in particular 2.

In a first embodiment variant, a polymeric or oligomeric active agent according to the present invention is a homopolymer. It is hereby provided that the amine mixture comprises the triamine dietylenetriamine or that the amine mixture comprises diamine 4,4′-methylenebis(cyclohexylamine).

In another embodiment variant, the amine mixture comprises one first component and at least one second component. The first component is a diamine or a triamine selected from the group comprising diamine, which comprises at least one cycloaliphatic residue, and dialkylenetriamine. The second component is a diamine or a triamine selected from the group comprising diamine, which comprises at least one cycloaliphatic residue, dialkylenetriamine, alkylenediamine and oxyalkylenediamine. The first component is different than the second component.

It is hereby particularly favorable if the first component is a diamine or a triamine selected from the group 4,4′-methylenebis(cylcohexylamine), diethylenetriamine; the second component is a diamine or a triamine selected from the group 4,4′-methylenebis(cyclohexylamine), diethylenetriamine, hexamethylenediamine, triethyleneglycoldiamine; and, the first component is different than the second component.

In particular, polymeric or oligomeric active agents, of which the first component is 4,4′-methylenebis(cyclohexylamine) and the second component is selected from diethylenetriamine, hexamethylenediamine, triethyleneglycoldiamine or of which the first component is diethylenetriamine and the second component is selected from hexamethylenediamine and triethyleneglycoldiamine, are hereby particularly advantageous. Furthermore, it is favorable if the first component and the second component are available in a molar ratio of 4:1 to 1:4, preferably 2:1 to 1:2.

Another advantage of the invention is recognizable in the method for production of the polymeric or oligomeric active agents according to the present invention comprising the following steps:
a) Placing one equivalent of guanidinehydrochloride
b) Adding one equivalent of the amine mixture
c) Heating to 140° C. to 180° C., preferably 145° C. to 175° C., particularly preferably 150° C. to 170° C.
d) Stirring the melt at the temperature provided in step d), namely at 140° C. to 180° C., preferably at 145° C. to 175° C., particularly preferably at 150° C. to 170° C. until the gas formation is completed, but for at least 5 hours.

Furthermore, one recognizes the advantage of a composition according to the present invention comprising at least one polymeric or oligomeric active agent according to the present invention, wherein the composition is a plastic granule. It is hereby favorable if the composition also comprises at least one plastic, preferably at least one thermal polymer, in particular selected from polyurethane, polyolefin, polyvinylchloride, polypropylene, polycarbonate, polystyrene, polyethersulfone, silicon and polyamide.

It is also hereby particularly preferable if the polymeric or oligomeric active agent is covalently bonded to the plastic, wherein the plastic is preferably a thermoplastic polymer, which is preferably a thermoplastic polymer selected from the group comprising thermoplastic aliphatic and aliphatic/aromatic polyurethanes, aliphatic and aliphatic/aromatic polyesters, aliphatic and aliphatic/aromatic polyamides, aliphatic and aliphatic/aromatic polycarbonates, aliphatic and aliphatic/aromatic polyureas, aliphatic and aliphatic/aromatic polyesteramides and wherein the polymeric or oligomeric active agent comprises cyclic structures in the main chain.

In particular, it is advantageous if the polymeric or oligomeric active agent comprises a structure selected from the group consisting of

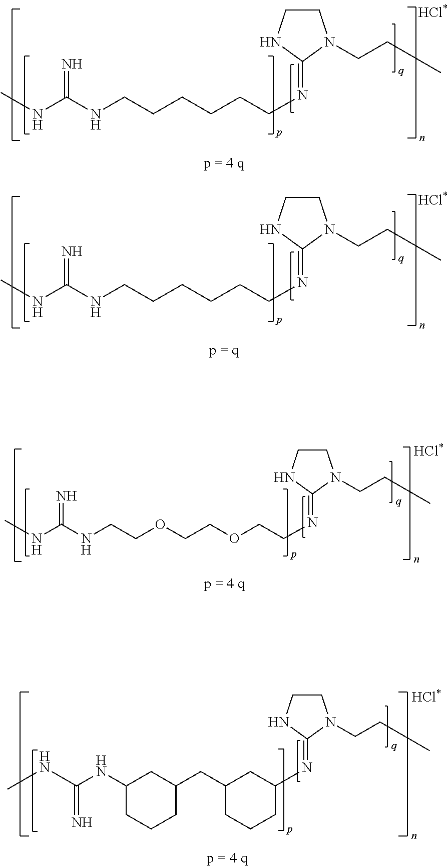

In these structures, HCl* means that the HCl is not covalently bonded; n is a natural number, preferably from 1 to 20, more preferably from 2 to 16 and particularly preferably from 3 to 8; and, p, q and r are integers which define the preferred molar ratio of the structure fragments to one another in the formulas.
In these structures, HCl* means that the HCl is not covalently bonded; n is a natural number, preferably from 1 to 20, more preferably from 2 to 16 and particularly preferably from 3 to 8; and, p, q and r are integers which define the preferred molar ratio of the structure fragments to one another in the formulas.

Also favorable is the method for the production of a plastic granule, i.e. a method for the production of a composition according to what was stated above, comprising the steps
a) Combination and mixing of a polymeric or oligomeric active agent with biocidal effect according to the present invention with a thermoplastic polymer,
b) Granulating the mixture created under step a).

The polymeric or oligomeric active agent is hereby added to the thermoplastic polymer in liquid form, and the mixing in step a) takes place in an extruder. The thermoplastic polymer is selected from the group comprising polyurethane, polyolefin, polyvinylchloride, polypropylene, polycarbonate, polystyrene, polyethersulfone, silicon and polyamide.

It is hereby particularly favorable if the thermoplastic polymer is a thermoplastic aliphatic polyurethane (TAPU) or a thermoplastic aliphatic/aromatic polyurethane (TAAPU) and if the polymeric or oligomeric active agent comprises a cyclic structure, which is selected from the group comprising

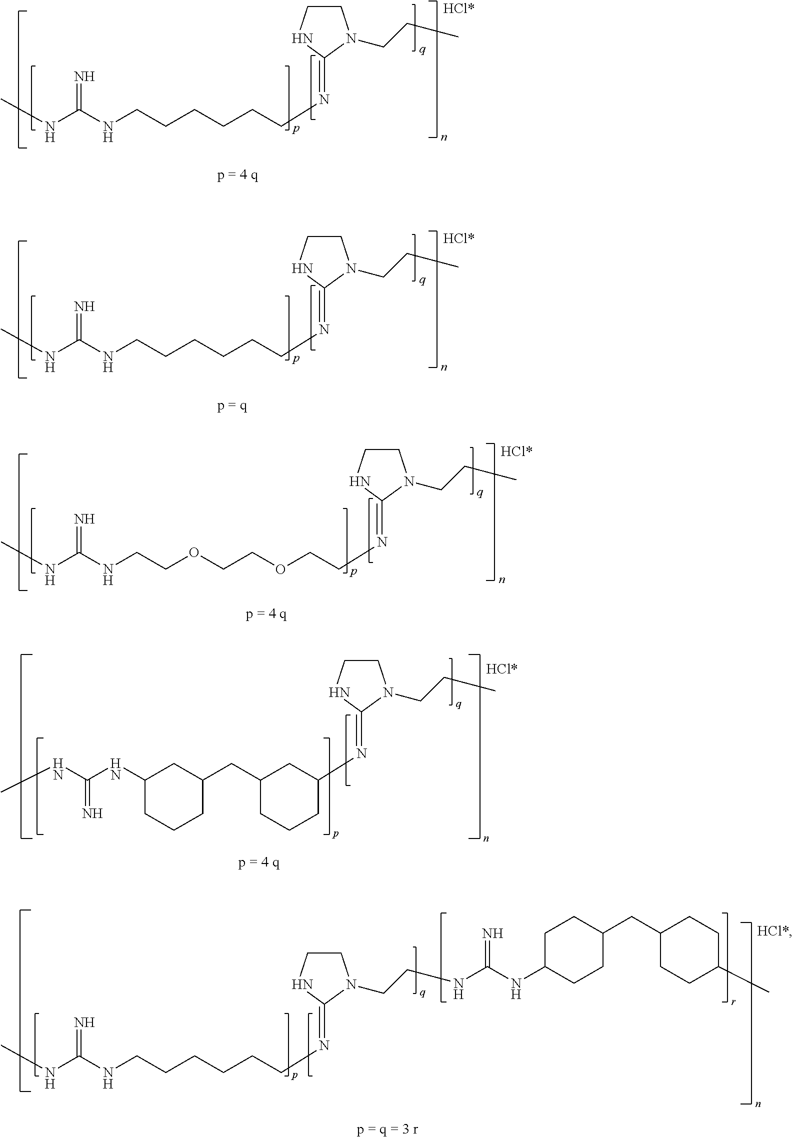

In these structures, HCl* means that the HCl is not covalently bonded; n is a natural number, preferably from 1 to 20, more preferably from 2 to 16 and particularly preferably from 3 to 8; and, p, q and r are integers which define the preferred molar ratio of the structure fragments to one another in the formulas.

It is furthermore favorable if the thermoplastic polymer is extruded at a mass temperature of more than 120° C., preferably of more than 140° C., particularly preferably of more than 160° C., and very particularly preferably at 170° C., and if the thermoplastic polymer is additivated with a 20 to 50% aqueous solution, preferably a 30 to 50% aqueous solution, particularly preferably a 40% aqueous solution of the polymeric or oligomeric active agent.

One recognizes the particular advantage of using a polymeric or oligomeric active agent according to the present invention for the production of apparel fabrics, functional textiles, antibacterial papers, technical filters, packaging materials for food and cosmetics and/or articles of daily use in the medical sector.

One furthermore recognizes the advantage of using a composition according to the present invention, in particular a plastic granule, for the production of apparel fabrics, functional textiles, antibacterial papers, technical filters, packaging materials for food and cosmetics and/or articles of daily use in the medical sector.

All of the characteristics and advantages originating from the claims, description and figures, including constructive details, spatial arrangements and steps of the method, are suitable to be essential to the invention, both in themselves and in the most diverse combinations.

1. Polymeric or oligomeric active agents with a biocidal effect which are obtainable via the polycondensation of a guanidine acid addition salt with
one individual amine compound, whereby homopolymers of said active agents are formed, or
an amine mixture comprising one first component and at least one second component, whereby
copolymers of said active agents are formed,
the first component is a diamine comprising at least one cycloaliphatic residue, or a dialkylenetriamine,
the second component is selected from the group consisting of a diamine comprising at least one cycloaliphatic residue, a dialkylenetriamine, an alkylenediamine, and an oxyalkylenediamine, and
the first component is different than the second component. at least one diamine and/or one triamine, wherein at least one amine is selected from the group comprising i) diamine, comprising at least one cycloaliphatic residue, and ii) dialkylenetriamine.

2. Polymeric or oligomeric active agents according to claim 1, wherein the individual amine compound is selected from the group consisting of 4,4′-methylenebis(cyclohexylamine) and diethylenetriamine.

3. Polymeric or oligomeric active agents according to claim 1, wherein the guanidine acid addition salt is guanidinehydrochloride.

4. Polymeric or oligomeric active agents according to claim 1, wherein the alkyenediamine of the amine mixture comprises a compound of the general formula NH₂(CH₂)ₙNH₂, in which n is an integer between 2 and 10, and/or the oxyalkylenediamine of the amine mixture comprises a compound of the general formula NH₂[(CH₂)₂O]ₙ(CH₂)₂NH₂, in which n is an integer between 2 and 5.

5. (canceled)

6. (canceled)

7. (canceled)

8. (canceled)

9. (canceled)

10. (canceled)

11. Polymeric or oligomeric active agents according to claim 1, wherein
the first component is 4,4′-methylenebis(cyclohexylamine) and the second component is selected from the group consisting of diethylenetriamine, hexamethylenediamine, triethyleneglycoldiamine or
the first component is diethylenetriamine and the second component is selected from the group consisting of hexamethylenediamine and triethyleneglycoldiamine.

12. (canceled)

13. Polymeric or oligomeric active agents according to claim 1, wherein the first component and the second component are present in a molar ratio of 4:1 to 1:4.

14. Method for the production of polymeric or oligomeric active agents according to claim 1, the method comprising the steps of:
(a) providing one equivalent of guanidinehydrochloride;
(b) adding one equivalent of the amine or of the amine mixture;
(c) heating to 140° C. to 180° C.; and
(d) stirring the melt at the temperature provided in step (c).

15. Composition comprising at least one polymeric or oligomeric active agent according to claim 1, wherein the composition is a plastic granule, and wherein the composition further comprises at least one plastic.

16. Composition according to claim 15, wherein the plastic comprises at least one thermoplastic polymer selected from the group consisting of polyurethane, polyolefin, polyvinylchloride, polypropylene, polycarbonate, polystyrene, polyethersulfone, silicon and polyamide.

17. Composition according to claim 16, wherein the polymeric or oligomeric active agent is covalently bonded to the plastic.

18. Composition according to claim 17, wherein the thermoplastic polymer is selected from the group consisting of thermoplastic aliphatic and aliphatic/aromatic polyurethanes, aliphatic and aliphatic/aromatic polyesters, aliphatic and aliphatic/aromatic polyamides, aliphatic and aliphatic/aromatic polycarbonates, aliphatic and aliphatic/aromatic polyureas, aliphatic and aliphatic/aromatic polyesteramides.

19. (canceled)

20. Composition according to claim 15, wherein the polymeric or oligomeric active agent comprises cyclic moieties and a structure selected from the group consisting of 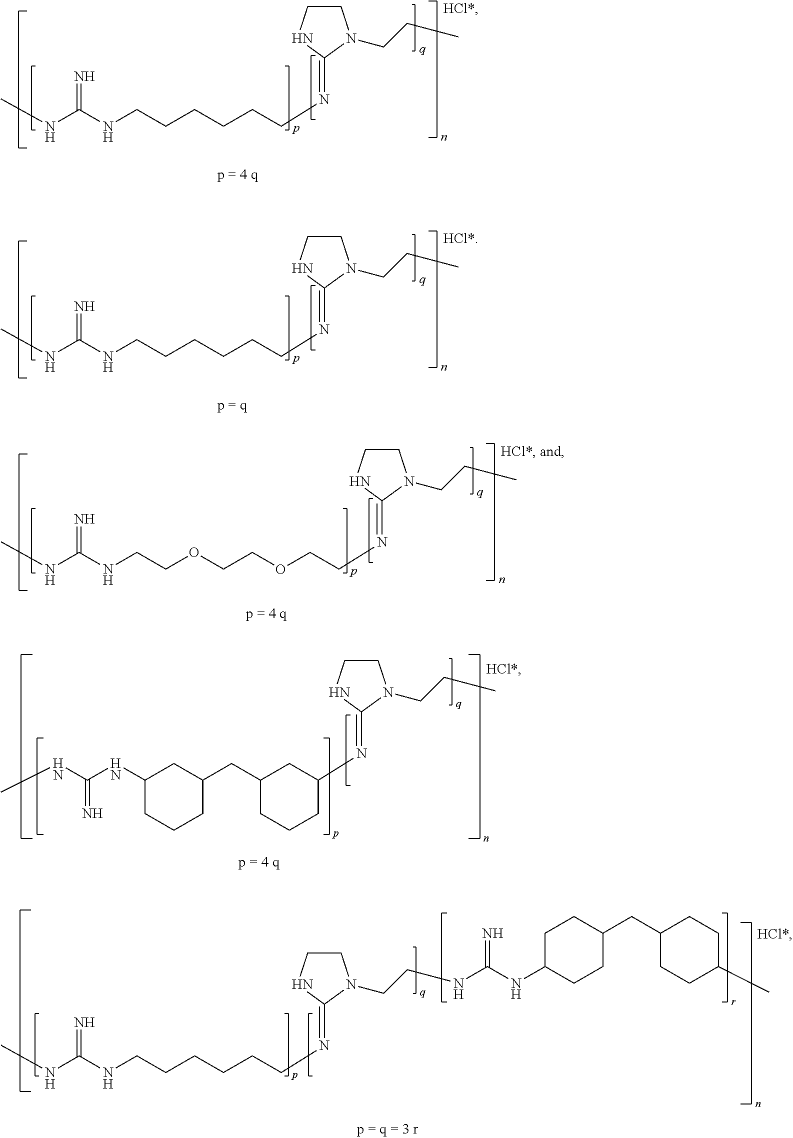
wherein
HCl* refers to HCl that is not covalently bonded,
n is a natural number from 1 to 20, and
p, q, and r are integers.

21. Composition comprising at least one polymeric or oligomeric active agent according to claim 1, which is obtainable via the reaction of
(a) said polymeric or oligomeric active agent with
(b) a plastic,
wherein the polymeric or oligomeric active agent is covalently bonded to the plastic.

22. Method for the production of a composition according to claim 1, the method comprising the steps:
(a) combining and mixing liquid form of the polymeric or oligomeric active agent with a thermoplastic polymer selected from the group consisting of polyurethane, polyolefin, polyvinylchloride, polypropylene, polycarbonate, polystyrene, polyethersulfone, silicon and polyamide, and
(b) granulating the mixture created via step (a).

23. (canceled)

24. Method according to claim 22, wherein the mixing in step (a) takes place in an extruder.

25. (canceled)

26. Method according to claim 22, wherein the thermoplastic polymer is a thermoplastic aliphatic polyurethane (TAPU) or a thermoplastic aliphatic/aromatic polyurethane (TAAPU), and wherein the polymeric or oligomeric active agent comprises a cyclic structure selected from the group consisting of: 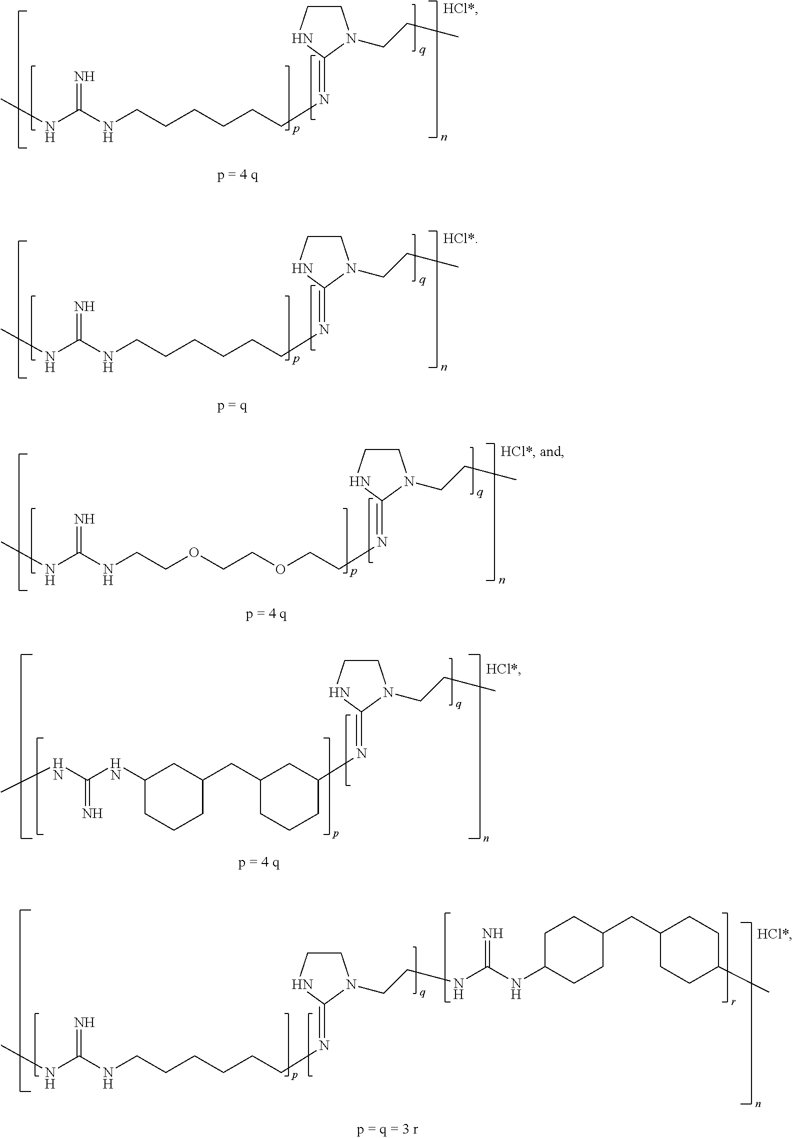
wherein
HCl* refers to HCl that is not covalently bonded,
n is a natural number from 1 to 20, and
p, q, and r are integers.

27. Method according to claim 26, wherein the thermoplastic polymer is extruded at a mass temperature of more than 120° C., and the thermoplastic polymer is additivated with a 0.1 to 90% aqueous solution of the polymeric or oligomeric active agent.

28. (canceled)

29. (canceled)

30. (canceled)
